(19) United States
(12) Patent Application Publication
(10) Pub. No.: US 2007/0036897 A1
(43) Pub. Date: Feb. 15, 2007

(54) Method and device for producing a corrosion-resistant and oxidation-resistant and oxidation-resistant coating

(76) Inventors: Josef Linska, Grafing (DE); Heinrich Walter, Friedberg (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/564,141

(22) PCT Filed: Jul. 3, 2004
(86) PCT No.: PCT/DE04/01425

§ 371 Date: Sep. 21, 2006

(30) Foreign Application Priority Data
Jul. 11, 2003 (DE) 103 31 351.6

(51) Int. Cl. B05D 5/00; B05D 3/00; B05D 7/00; B05D 1/18; B05B 13/06

(52) U.S. Cl. 427/256; 427/372.2; 427/402; 427/421.1; 427/430.1; 427/429; 427/299; 118/308; 118/306

(57) ABSTRACT

A method and apparatus for producing a corrosion-resistant and oxidation-resistant coating for a component is disclosed. A paste which contains exclusively at least one metal of the platinum group in addition to a binder is applied to the component. After curing and/or drying the paste, the component coated with the paste is aluminized.

### BACKGROUND AND SUMMARY OF THE INVENTION

This application claims the priority of International Application No. PCT/DE2004/001425, filed Jul. 3, 2004, and German Patent Document No. 103 31 351.6, filed Jul. 11, 2003, the disclosures of which are expressly incorporated by reference herein.

This invention relates to a method for producing a corrosion-resistant and oxidation-resistant coating. In addition, the invention relates to a device for producing a corrosion-resistant and oxidation-resistant coating and a component having such a coating.

In operation of components, in particular components of gas turbines at high temperatures, their free surface areas are often exposed to highly corrosive and oxidizing conditions. For use in gas turbines, such components may be made of a superalloy based on nickel or cobalt, for example. The components are provided with coatings made of metal powders to protect them from corrosion, oxidation or erosion.

German Patent Document DE 198 07 636 C1 describes a method for producing a corrosion-resistant and oxidation-resistant slurry layer. With the method described there, a slip material is prepared by mixing a binder solution with a starting powder containing aluminum or chromium and an added powder containing at least one element from the group consisting of aluminum, platinum, palladium or silicon, whereby the added powder does not include any aluminum in the event when the starting powder contains exclusively aluminum. According to the method described there, the slip material prepared in this way is then applied to a component and next hardened. A heat treatment is performed after hardening to cause the slip layer to diffuse into the component. Therefore, in the method described in German Patent Document DE 198 07 636 C1, an added powder and a starting powder are combined and this mixture of different metal groups is applied to the component in one step.

Against this background, the problem on which the present invention is based is to create a novel method and a novel device for producing a corrosion-resistant and oxidation-resistant coating and a component having such a coating.

According to this invention, the method includes the following steps: preparing a paste which contains, in addition to a binder, exclusively at least one metal of the platinum group as the metal; preferably diluting the paste; then applying the preferably diluted paste to the component; then drying and heat-treating the component coated with the paste; then aluminizing the component coated with the paste.

In contrast with the state of the art already discussed, it is thus within the sense of the inventive method to apply to the component a paste containing only metals of the platinum group as the metal in a first step and then in a second step to perform the aluminizing of the component coated with the paste after drying and heat treatment of the component coated with the paste. The core of the present invention consists of selecting an appropriate paste on the one hand and performing the aluminizing in an independent method step on the other hand. It has been found that effective protection of turbine blades from oxidation and corrosion, in particular sulfidation and/or high-temperature corrosion, can be ensured with the coating provided herein.

According to an advantageous embodiment of the present invention, the paste contains platinum and/or palladium in addition to a binder as metal. The composition of the undiluted paste is preferably as follows: palladium in an amount of25-35 wt %, platinum in an amount of 25-35 wt %, terpineol in an amount of 15-25 wt %, resin in an amount of 10-20 wt % and turpentine in an amount of 1-5 wt %.

Preferred embodiments of this invention are derived from the following description.

### BRIEF DESCRIPTION OF THE DRAWINGS

FIG. 1 shows a component which is coated with the paste and is positioned in a device in accordance with the principles of the present invention.

### DETAILED DESCRIPTION OF THE DRAWINGS

An exemplary embodiment of the inventive method is described in greater detail below, although it is not limited to that embodiment.

To produce the corrosion-resistant and oxidation-resistant coating for a component, the surfaces of the component to be coated are blasted to obtain a bare metallic surface on the component. Instead of sandblasting, of course any other method may also be used to obtain a bare metallic surface.

A paste is prepared as described below. In addition to containing a binder, the paste contains only at least a metal of the platinum group as the metal.

The paste may be, for example, a high-purity platinum paste which contains terpineol as the binder and contains only platinum as the metal. The composition of this high-purity platinum paste contains platinum in an amount of 85-90 wt % and terpineol in an amount of 10-15 wt %.

However, it is preferable to use a platinum-palladium paste which contains palladium in an amount of 25-35 wt %, platinum in an amount of 25-35 wt %, alpha-terpineol in an amount of 25-35 wt %, resin in an amount of 10-20 wt % and turpentine in amount of 1-5 wt %.

The paste is then applied to the component. Before applying the paste, it is preferably diluted. Therefore, a dilute paste having a low viscosity is prepared and is more suitable for application to the component. Suitable diluents include a turpentine oil, for example. Preferably 2 to 4 mL, in particular 2.5 to 3 mL turpentine oil is used as the diluent per 5 grams of undiluted paste.

The paste is applied by spraying, painting, dipping, flooding, casting or screen printing. The decision as to how the paste is to be applied to the component will of course also depend on the areas of the component to which the paste is to be applied. If the paste is to be applied to the entire component, dipping may be preferred. However, if the paste is to be applied only to selected areas, then spraying or painting would be preferred.

After applying the paste to the component and/or to corresponding sections of the component, the paste is hardened, i.e., dried with a subsequent heat treatment. The heat treatment causes the metals of the paste to diffuse into the component. This may be accomplished by diffusion annealing or vacuum annealing, which are known from the state of the art.

The application, drying and heat treatment (diffusion) of the paste are repeated until achieving a defined and/or desired coating of the component with the metals of the paste, i.e., with platinum and/or palladium.

It should be pointed out here that the paste may also be changed in a case of repeated application, drying and heat treatment. Thus in a first step, a paste containing only platinum may be applied, and then in a repeat step following the first step, a paste containing platinum and palladium may be used, and in a second repeat step, a paste containing only palladium may be used. The coating may be adjusted with precision through a suitable selection of pastes and combination thereof in the repeat steps.

After drying the paste and after the metals of the paste have diffused into the component, then the component coated with the paste is aluminized, i.e., coated with aluminum. The aluminizing may be performed as gas diffusion aluminizing or powder packing aluminizing. The details of this aluminizing will be conventional with those skilled in the art relevant to the present invention. Aluminizing is performed only after the optionally repeated application, drying and heat treatment of the component coated with the paste.

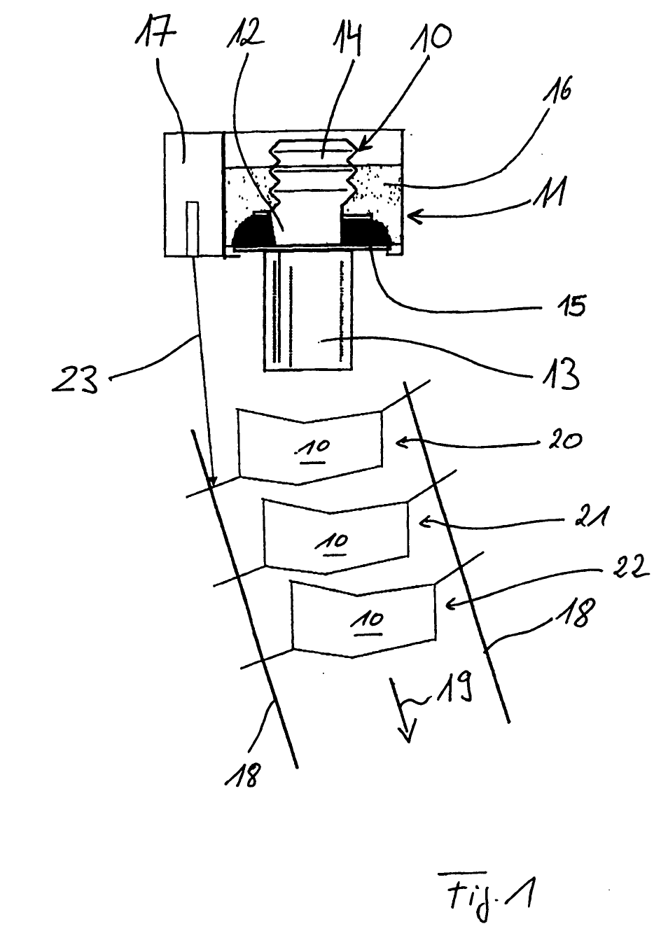

In aluminizing, it is possible to proceed as illustrated in FIG. 1, for example. FIG. 1 shows a component 10 which is coated with the paste and is positioned in an inventive device 11. Component 10 is a turbine blade. A so-called damper pocket area 12 of the turbine blade is to be provided with the coating. As FIG. 1 shows, the pan 13 of a paddle protrudes downward out of the inventive device 11, with the damper pocket area 12 and the blade footing 14, which is connected to the damper pocket area 12 being situated inside the inventive device 11.

The damper pocket area 12 of the component 10, which has already been coated with paste and is to be coated again, is surrounded by an aluminizing paste 15. The aluminizing paste 15 is covered by a covering powder 16, whereby the covering powder 16 is in the form of Al₂O₃ mixed with an activator. This makes it possible to compensate for a possible loss of activator during the aluminizing process. Aluminizing is performed at 700° C. to 1150° C. under a protective gas atmosphere. Argon or helium may be used as the protective gas and/or inert gas. The aluminizing process illustrated in FIG. 1 is powder-packing aluminizing. Due to the fact that the turbine blade 10 to be coated is positioned with the blade footing 14 facing upward in the device 11, the aluminizing paste 15 and the covering powder 16 act on the damper pocket area 12 of the turbine blade 10 to be coated under the influence of gravitational force.

The inventive device 11 is designed as a capsule-shaped container made of sheet metal which has a passage for the blade 13 in its bottom area. With the turbine blade 10 positioned in the container, the aluminizing paste 15 and the covering powder 16 together with the activator can be introduced into the container. A charging mechanism 17, which is arranged next to the device 11 in FIG. 1, is used for this purpose.

Below the blade 13 can be seen in a highly schematic diagram a top view of three components 10 which are advanced in the direction of arrow 19 by conveyor devices 18 arranged at the side next to the components 10 and are thereby moved through different stations 20, 21 and 22. The charging device 17 is positioned in the area of station 20 in the exemplary embodiment shown here as indicated by the arrow 23. A furnace (not shown) for the aluminizing under a protective gas atmosphere is positioned in the direction of movement downstream from the charging device 17.

It is thus a finding of the present invention that a corrosion-resistant and oxidation-resistant coating may be provided by applying a paste to the component in a first step, whereby the paste contains exclusively metals of the platinum group as the metal in addition to containing a binder. Then the aluminizing is performed in a second step. Since the paste is preferably diluted, the first step is preferably repeated.

The paste with the metal and/or metals of the platinum group is not applied by a galvanic method but instead as a so-called slip layer by painting, spraying or the like. This may be accomplished with little complexity and therefore has advantages in terms of manufacturing technology.

According to another aspect of the present invention, the paste is applied only to selected areas of the turbine blades, namely to the surfaces of the turbine blades that are not exposed to flow. It has thus been found that especially effective protection from sulfidation and/or high-temperature corrosion can be achieved in the so-called damper pocket area of turbine blades by using the coating according to this invention. Cavities in cooling channels of gas turbine blades can also be protected well from sulfidation in this way.

1-15. (canceled)

16. A method for producing a corrosion-resistant and oxidation-resistant coating for an area of a turbine blade of a gas turbine not exposed to flow by preparing a paste which contains, in addition to a binder, exclusively at least one metal of a platinum group as the metal, applying the paste to the blade in at least some areas and drying and heat-treating the blade coated with the paste in at least some areas, aluminizing in at least some areas the blade coated with the paste in at least some areas by using an aluminizing paste or an aluminizing powder on the area of the blade to be coated, wherein the aluminizing paste or the aluminizing powder is coated completely with a covering powder.

17. The method according to claim 16, wherein the paste is diluted to form a dilute paste before applying it.

18. The method according to claim 16, wherein the paste contains exclusively platinum and/or palladium as the metal.

19. The method according to claim 16, wherein the paste contains exclusively platinum as the metal and terpineol as the binder.

20. The method according to claim 16, wherein the paste contains exclusively platinum and palladium as the metals.

21. The method according to claim 20, wherein the paste has the following composition:
palladium in an amount of 25-35 wt %;
platinum in an amount of 25-35 wt %;
terpineol in an amount of 15-25 wt %;
resin in an amount of 10-20 wt %; and
turpentine in an amount of 1-5 wt %.

22. The method according to claim 16, wherein the paste is diluted with a turpentine oil to form a low-viscosity paste.

23. The method according to claim 16, wherein the paste is applied to the blade by spraying, painting, dipping, flooding or screen printing.

24. The method according to claim 16, wherein the blade is blasted before applying the paste.

25. The method according to claim 16, wherein the metal or each metal present in the paste diffuses into the blade during heat treatment of the blade which is coated with the paste in at least some areas.

26. The method according to claim 16, wherein the preparation of paste and application of paste are repeated until the blade has a defined platinum and/or palladium coating and then the aluminizing is performed.

27. The method according to claim 16, wherein the area not exposed to flow is a damper pocket area of the turbine blade.

28. A device for producing a corrosion-resistant and oxidation-resistant coating for an area of a turbine blade of a gas turbine not exposed to flow, in particular for coating a damper pocket area of a turbine blade, with a housing for accommodating the blade coated with a paste in at least some areas, wherein the blade is positionable in the housing so that an aluminizing paste introduceable into the housing together with a covering powder acts on the area of the blade to be coated under the influence of gravitational force.

29. The device according to claim 28, wherein the housing has a through-opening in a bottom area so that a pan of the blade protrudes downward through the through-opening, and the damper pocket area of the turbine blade to be coated together with a blade foot protrudes into the housing.

30. The device according to claim 28, wherein a charging mechanism is positioned in an area of a station through which the housing together with the blade positioned in the housing is moving, wherein the charging mechanism introduces the aluminizing paste and the covering powder into the housing.

31. A method for coating an area not exposed to flow of a turbine blade of a gas turbine, comprising the steps of:
preparing a paste which contains, in addition to a binder, exclusively at least one metal of a platinum group;
applying the paste only to the area;
drying and heat-treating the paste at the area;
aluminizing the area with an aluminizing paste or an aluminizing powder; and
coating the aluminizing paste or the aluminizing powder with a covering powder;
wherein the aluminizing paste or the aluminizing powder and the covering powder aluminize and coat the area, respectively, by using gravity.

32. The method according to claim 31, wherein the area is a damper pocket area of the blade, and further comprising the steps of:
placing the damper pocket area and a blade footing of the blade in a device for performing the aluminizing and coating steps; and
positioning the blade footing facing upward in the device.

33. A device for producing a corrosion-resistant and oxidation-resistant coating for an area not exposed to flow of a turbine blade of a gas turbine, comprising:
a housing for receiving the area not exposed to flow of the turbine blade;
wherein an aluminizing paste or aluminizing powder and a covering powder are introduceable into the housing such that the area is aluminizable with the aluminizing paste or the aluminizing powder and coatable with the covering powder by using gravity.
